(19) United States
(12) Patent Application Publication
(10) Pub. No.: US 2008/0014855 A1
(43) Pub. Date: Jan. 17, 2008

(54) Fan

(75) Inventor: Dominique Leserre, Montry (FR)

Correspondence Address: YOUNG & THOMPSON, 745 SOUTH 23RD STREET, 2ND FLOOR, ARLINGTON, VA, 22202, US

(73) Assignee: Faurecia Interieur Industrie, Nanterre (FR)

(21) Appl. No.: 11/630,119

(22) PCT Filed: Jun. 22, 2005
(86) PCT No.: PCT/FR05/01579

§ 371 Date: Dec. 20, 2006

(30) Foreign Application Priority Data
Jun. 24, 2004 (FR) 0406935

(51) Int. Cl. B60H 1/34

(52) U.S. Cl. 454/155

(57) ABSTRACT

An aerator includes a ventilation conduit (4) provided with an output pipe (16) delimiting the aerator output opening (10). The aerator also compressed an air-guiding element (22) which is disposed in the output pipe (16) and is movable between two ventilation positions. The air-guiding element and the output pipe define therebetween the ventilation positions of the air discharge cross-sections. The aerator includes only one air-guiding element (22) and the discharge sections are embodied in such a way that they guide an airflow (F) in different output directions (D1, D2). The invention is usable for motor vehicle aerators.

The present invention relates to a fan, of the type comprising a ventilation conduit which is provided with an outlet section which delimits an outlet opening of the fan, the fan further comprising an air-guiding element which is arranged in the outlet section and which can be moved between at least two ventilation positions, the air-guiding element and the outlet section together defining, in each of the ventilation positions, an air-flow cross-section.

The invention can also advantageously be used in the field of automotive production.

Document EP-A-937 596 discloses a fan which comprises a ventilation conduit which is provided with an outlet section which delimits an outlet opening of the fan. The fan further comprises a fin carrier on which there is arranged a plurality of movable air-guiding fins. The orientation of the fins relative to the ventilation conduit can be modified by changing the orientation of the fin carrier.

In this fan, the flow cross-sections which determine the outlet directions of a flow of air are delimited exclusively by the fins, the air conduit itself not contributing to guiding the flow of air.

This fan has a complex construction, which leads to high production and assembly costs.

The object of the invention is to overcome this disadvantage and provide a fan which is economic to produce.

To this end, the invention relates to a fan of the above-mentioned type, characterised in that the fan comprises a single air-guiding element, and in that the flow cross-sections are capable of guiding a flow of air in different outlet directions.

According to other embodiments, the fan according to the invention comprises one or more of the following features.

the air-guiding element comprises, over substantially the entire length thereof, a single air-guiding surface which delimits, with the outlet section, in each of the ventilation positions, the flow cross-section;

the fan comprises a connection portion which is fixed to the air-guiding element, which is arranged upstream of the outlet section, and which connects the air-guiding element to the ventilation conduit, so that the air-guiding element can be moved between the at least two ventilation positions thereof, and the air-guiding element is out of alignment relative to the connection portion;

the ventilation conduit comprises a connection section which is located upstream of the outlet section, and the connection portion is arranged in the connection section;

the air-guiding element and the connection portion are produced in one piece;

the air-guiding element is connected to the ventilation conduit only by means of the connection portion;

the outlet section has a cross-section which widens or narrows towards the outlet opening and, in each of the ventilation positions of the air-guiding element, the surface of the flow cross-section is substantially constant over the length of the outlet section;

the ventilation conduit comprises an intermediate section which is connected, at the upstream side, to the outlet section, and this intermediate section has a cross-section which narrows towards the outlet opening if the outlet section has a cross-section which widens towards the outlet opening or has a cross-section which widens towards the outlet opening if the outlet section has a cross-section which narrows towards the outlet opening;

the air-guiding element is arranged in the ventilation conduit between the two ventilation positions thereof so as to be able to be moved in terms of rotation about a first pivot axis;

the connection section comprises an inner connection surface which, when viewed along the first pivot axis, has a profile in the form of a circular arc;

the air-guiding element is arranged in the ventilation conduit between the two ventilation positions thereof so as to be able to be moved in terms of rotation about a second pivot axis, which extends perpendicularly relative to the first pivot axis;

the first pivot axis and second pivot axis intersect so that the air-guiding element can be moved about a pivot point;

the air-guiding element is symmetrical relative to a plane which extends perpendicularly relative to the first pivot axis, and in particular has a shape generated by revolution about a center axis; and

the outlet section has a cross-section which narrows towards the outlet opening, and the air-guiding element is substantially in the form of a water droplet which is directed counter to the air outlet.

The invention will be better understood from a reading of the following description, given purely by way of example and with reference to the appended drawings, in which:

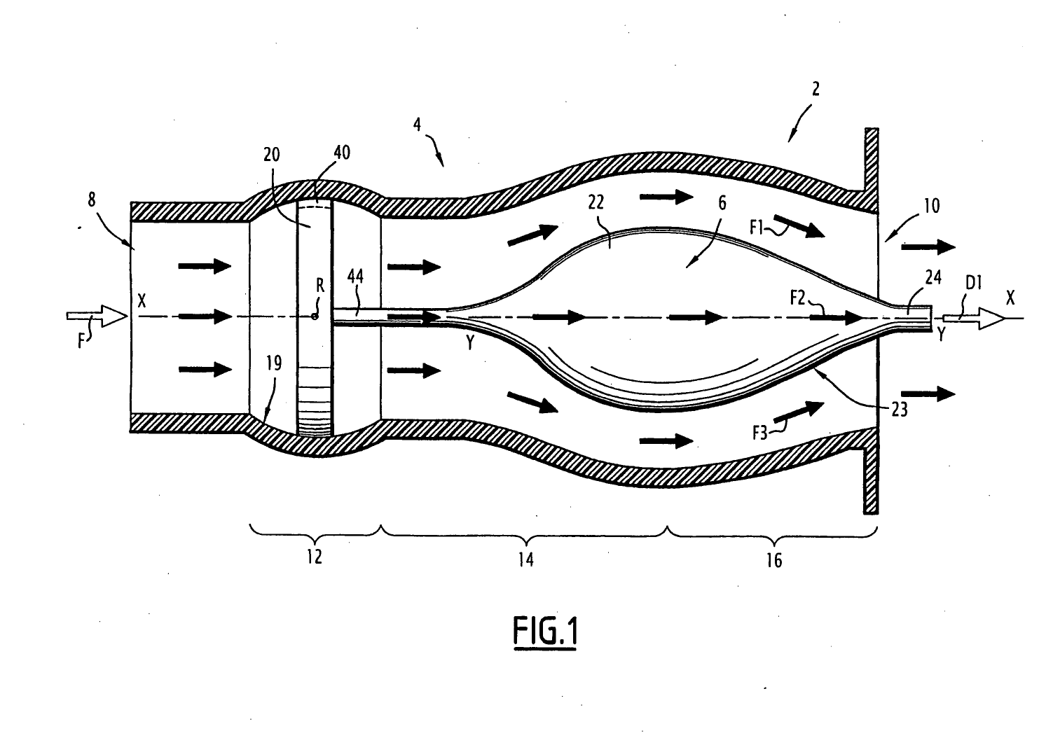

FIG. 1 is a side view of a fan according to the invention in a first ventilation configuration, the ventilation conduit being illustrated in cross-section;

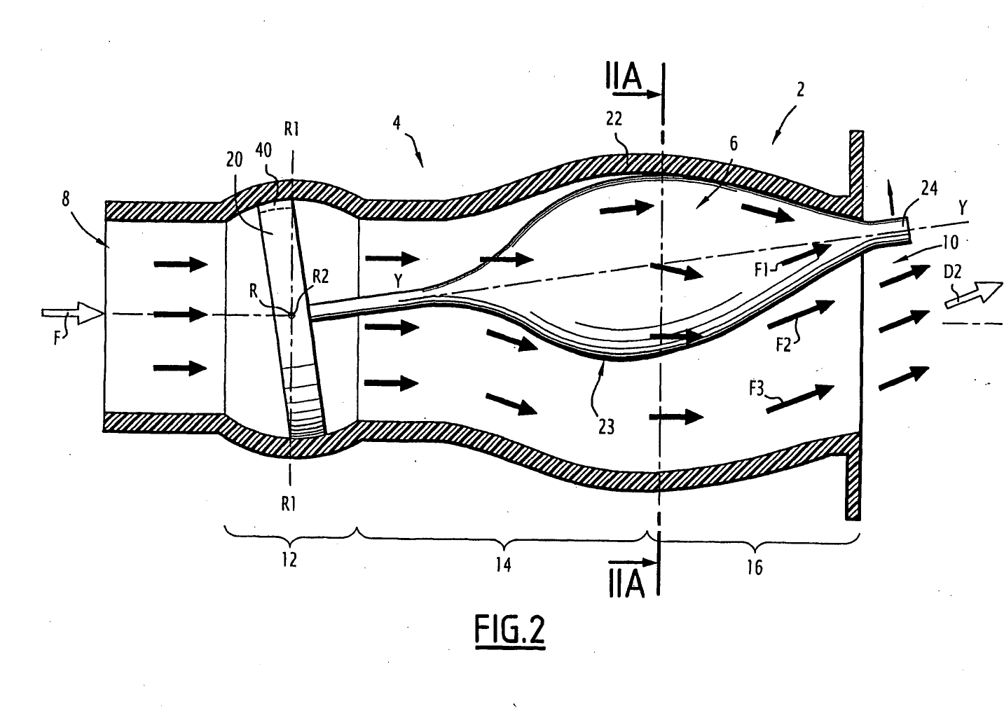

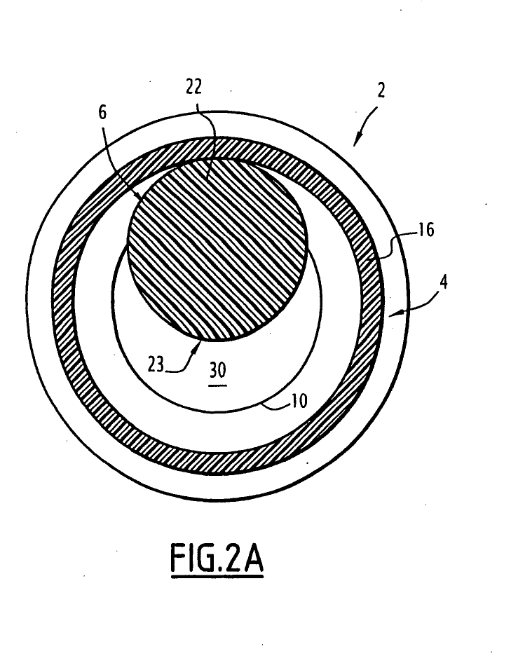

FIG. 2 is a view of the fan of FIG. 1 in a second ventilation configuration;

FIG. 2A is a cross-section along line IIA-IIA of FIG. 2;

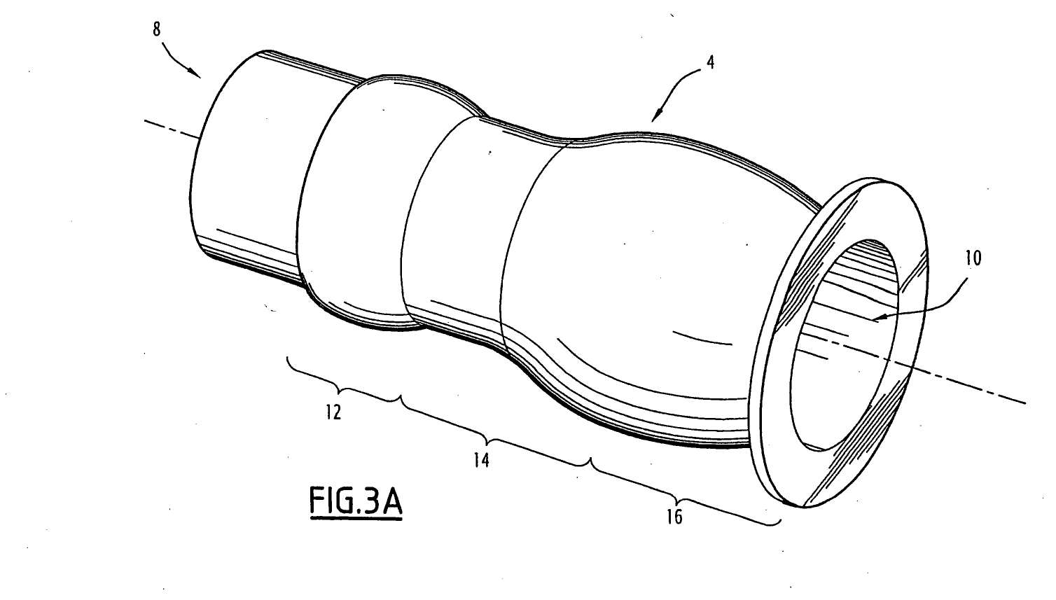

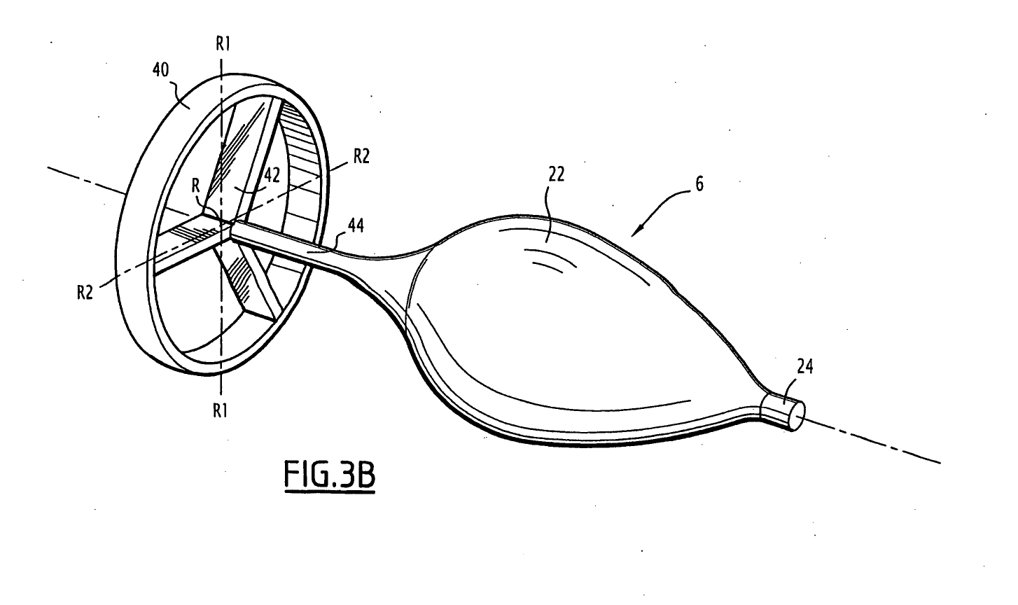

FIG. 3A is a perspective view of the ventilation conduit of the fan according to the invention; and

FIG. 3B is a perspective view of the air-guiding insert of the fan according to the invention.

FIGS. 1 and 2 illustrate a fan according to the invention, generally designated 2.

The fan 2 is particularly suitable for being used in a motor vehicle.

The fan 2 is constituted by a ventilation conduit 4 and a single air-guiding insert 6, arranged in the conduit 4. The ventilation conduit 4 is substantially a pipe which delimits an air inlet opening 8 and an air outlet opening 10. The ventilation conduit 4 is constituted successively, from the inlet opening 8 to the outlet opening 10, by a connection section 12, an intermediate section 14, and an outlet section 16.

The inlet opening 8 defines an upstream side of the fan, whilst the outlet opening 10 defines a downstream side of the fan 2.

The ventilation conduit 4 extends along an axis of symmetry X-X and has a shape which is generated by revolution about this axis X-X.

The intermediate section 14 has a cross-section which widens towards the outlet opening 10 and the outlet section 16 has a cross-section which narrows towards the outlet opening 10.

The connection section 12 delimits an annular inner surface 19 in the form of a partial sphere.

The guiding insert 6 is constituted, from the upstream side to the downstream side of the fan, by a connection portion 20, a single air-guiding element 22, and a gripping tip 24.

The gripping tip 24 protrudes beyond the outlet opening 10 for easy handling of the guiding element 22.

The air-guiding element 22 has a shape generated by revolution about an axis Y-Y, aligned with the axis X-X in FIG. 1. In this instance, the guiding element 22 is in the form of a water droplet which is directed counter to the air outlet 10. The guiding element 22 thus forms a single air-guiding surface 23.

The guiding element 22 has a cross-section which is smaller than the cross-section of the intermediate section 14 and outlet section 16. In a plane perpendicular relative to the axis X-X, the dimensions of the guiding element 22, in two perpendicular directions, are of the same order of magnitude. The guiding element 22, more precisely the surface 23 and the sections 14 and 16 thus define together, in each ventilation position, an air-flow cross-section 30 (FIG. 2A). The flow cross-section 30 has a transverse surface-area which is substantially constant over the entire length of the outlet section 16 and over the entire length of the intermediate section 14.

The connection portion 20 comprises a connection ring 40 which is provided with three spokes 42 (see FIG. 3B), and a connection rod 44. The guiding element 22 is fixed by means of the connection rod 44 and the spokes 42 to the connection ring 40 so that the element 22 is out of alignment relative to the connection portion 20.

The connection ring 40 has an outer diameter which is substantially identical to the inner diameter of the surface 19 of the section 12, so that the guiding element 22 can be moved in rotation independently about two pivot axes R1, R2 which are perpendicular and which intersect. That is to say, the guiding element 22 can be moved in the manner of a pivot about a pivot point R located on the axis X-X.

As can be seen from FIGS. 1 and 2, the guiding element 22 can thus be displaced by a user between a plurality of ventilation positions about the rotation point R. The connection of the guiding element 22 to the conduit 4 by means of the connection portion 20 and the section 12 is particularly simple.

Furthermore, the ring 40 co-operates by means of friction with the surface 19 so that the insert 6 is held relative to the conduit 4 counter to the force applied by its own weight. The guiding insert 6 is thus connected to the conduit 4 only by means of the ring 40 and other means for retaining the insert are not required.

Advantageously, the ventilation conduit 4 is produced by means of two assembled components which are separated along a longitudinal plane comprising the axis X-X, and the guiding element 22 and the connection portion 20 are produced in one piece, in particular by injecting plastics material. The fan 2 thus comprises only three components which can be readily assembled.

The fan according to the invention operates in the following manner.

The flow of a flow F of air in the fan, introduced into the opening 8, is carried out under an effect known as the “Coanda effect”.

When the guiding element 22 is in a central position, as illustrated in FIG. 1, the flow F of ventilation air flows in a substantially laminar manner in the air flow cross-section 30 around the element 22 and is discharged through the outlet opening 10 in a direction D1, parallel with the axis X-X. The partial flows F1, F2 and F3 of the air flow F have an identical speed.

When the guiding element 22 is offset from the central position thereof, for example, upwards, as indicated in FIG. 2, the flow F of air flows in a preponderant manner over the portion of the outlet section 16 opposite the element 22. Owing to the Coanda effect, the speed of the partial flow F1 is lower than the speed of the partial flows F2 and F3, and the air follows the portion of the wall of the section 16 opposite the element 22. Consequently, the flow F of air is discharged from the outlet opening 10 in a direction D2 which is inclined upwards relative to the center axis X-X.

In addition to the simplicity of production, the embodiment described above with reference to FIGS. 1 to 3B has the advantage that the movement of the gripping tip 24 in a given direction leads to deflection of the air in the same direction. This fan is therefore ergonomic.

In a variant, the intermediate section 14 has a cross-section which narrows towards the outlet opening 10, whilst the outlet section 16 has a cross-section which widens towards the outlet opening 10. In this instance, the guiding element 22 comprises a portion which is located in the section 14 which narrows towards the outlet opening 10 and a portion which is located in the section 16 which widens towards the outlet opening 10. This variant is also simple to produce.

1. Fan, of the type comprising a ventilation conduit (4) which is provided with an outlet section (16) which delimits an outlet opening (10) of the fan, the fan further comprising an air-guiding element (22) which is arranged in the outlet section (16) and which can be moved between at least two ventilation positions, the air-guiding element (22) and the outlet section (16) together defining, in each of the ventilation positions, an air-flow cross-section (30), the fan comprising a single air-guiding element (22), and the flow cross-sections (30) being capable of guiding a flow (F) of air in different outlet directions (D1, D2), the air-guiding element (22) comprising, over substantially the entire length thereof, a single air-guiding surface (23) which delimits, with the outlet section (16), in each of the ventilation positions, the flow cross-section (30), characterised in that the fan comprises a connection portion (20) which is fixed to the air-guiding element (22), which is arranged upstream of the outlet section (16), and which connects the air-guiding element (22) to the ventilation conduit (4), so that the air-guiding element (22) can be moved between the at least two ventilation positions thereof, and in that the air-guiding element (22) is out of alignment relative to the connection portion (20).

2. Fan according to claim 1, characterised in that the ventilation conduit (4) comprises a connection section (12) which is located upstream of the outlet section (16), and in that the connection portion (20) is arranged in the connection section (12).

3. Fan according to either claim 1, characterised in that the air-guiding element (22) and the connection portion (20) are produced in one piece.

4. Fan according to claim 1, characterised in that the air-guiding element (22) is connected to the ventilation conduit (4) only by means of the connection portion (20).

5. Fan according to claim 1, characterised in that the outlet section (16) has a cross-section which widens or narrows towards the outlet opening (10), and in that, in each of the ventilation positions of the air-guiding element (22), the surface of the flow cross-section (30) is substantially constant over the length of the outlet section (16).

6. Fan according to claim 5, characterised in that the ventilation conduit (4) comprises an intermediate section (14) which is connected, at the upstream side, to the outlet section (16), and in that this intermediate section (14) has a cross-section which narrows towards the outlet opening (10) if the outlet section (16) has a cross-section which widens towards the outlet opening (10) or has a cross-section which widens towards the outlet opening (10) if the outlet section (16) has a cross-section which narrows towards the outlet opening.

7. Fan according to claim 2, characterised in that the air-guiding element (22) is arranged in the ventilation conduit (4) between the two ventilation positions thereof so as to be able to be moved in terms of rotation about a first pivot axis (R1; R2).

8. Fan according to claim taken in combination, characterised in that the connection section (12) comprises an inner connection surface (19) which, when viewed along the first pivot axis (R1; R2), has a profile in the form of a circular arc.

9. Fan according to claim 7, characterised in that the air-guiding element (22) is arranged in the ventilation conduit (4) between the two ventilation positions thereof so as to be able to be moved in terms of rotation about a second pivot axis (R2; R1), which extends perpendicularly relative to the first pivot axis (R1; R2).

10. Fan according to claim 9, characterised in that the first pivot axis (R1; R2) and second pivot axis (R2; R1) intersect so that the air-guiding element (22) can be moved about a pivot point (R).

11. Fan according to claim 7, characterised in that the air-guiding element (22) is symmetrical relative to a plane which extends perpendicularly relative to the first pivot axis (R1; R2), and in particular has a shape generated by revolution about a center axis (Y-Y).

12. Fan according to claim 11, characterised in that the outlet section (16) has a cross-section which narrows towards the outlet opening, and in that the air-guiding element (22) is substantially in the form of a water droplet which is directed counter to the air outlet (10).

13. Fan according to either claim 2, characterised in that the air-guiding element (22) and the connection portion (20) are produced in one piece.

14. Fan according to claim 1, characterised in that the air-guiding element (22) is arranged in the ventilation conduit (4) between the two ventilation positions thereof so as to be able to be moved in terms of rotation about a first pivot axis (R1; R2).

15. Fan according to claim 8, characterised in that the air-guiding element (22) is arranged in the ventilation conduit (4) between the two ventilation positions thereof so as to be able to be moved in terms of rotation about a second pivot axis (R2; R1), which extends perpendicularly relative to the first pivot axis (R1; R2).

16. Fan according to claim 2, characterised in that the air-guiding element (22) is connected to the ventilation conduit (4) only by means of the connection portion (20).

17. Fan according to claim 3, characterised in that the air-guiding element (22) is connected to the ventilation conduit (4) only by means of the connection portion (20).

18. Fan according to claim 14, characterised in that the air-guiding element (22) is arranged in the ventilation conduit (4) between the two ventilation positions thereof so as to be able to be moved in terms of rotation about a second pivot axis (R2; R1), which extends perpendicularly relative to the first pivot axis (R1; R2).
